(19) United States
(12) Patent Application Publication
(10) Pub. No.: US 2009/0012894 A1
(43) Pub. Date: Jan. 8, 2009

(54) FINANCIAL ARRANGEMENT AND METHOD FOR ACQUIRING AN ASSET

(76) Inventor: Grayson M. Bass, Lubbock, TX (US)

Correspondence Address: Michael L. Diaz;Diaz and Associates, Suite 200, 555 Republic Drive, Plano, TX, 75074, US

(21) Appl. No.: 11/773,490

(22) Filed: Jul. 5, 2007

(51) Int. Cl. G06Q 40/00

(52) U.S. Cl. 705/39

(57) ABSTRACT

A system and method of acquiring an asset by a purchaser. The method begins by a purchasing entity purchasing an asset. A contractual relationship between the purchasing entity and the purchaser is then established. The purchaser agrees to pay a periodic fee to utilize the asset and equity is built by the purchaser in the asset by conducting specified transactions. The purchaser pays periodic fees, thereby allowing utilization of the asset. The purchaser conducts the specified transactions with a partnership entity affiliated with the purchasing entity. Equity is then built in the asset by the purchaser by conducting the specified transactions. Total ownership of the asset is transferred from the purchasing entity to the purchaser when the equity equals a specified amount. Additionally, transaction fees may be incurred by the partnership entity to the purchasing entity for each specified transaction. The asset may be any valuable item, such as a home, vehicle or other real or personal property.

### BACKGROUND OF THE INVENTION

1. Field of the Invention

This invention relates to finances. Specifically, and not by way of limitation, the present invention relates to a financial system and method for acquiring an asset.

2. Description of the Related Art

Home ownership is a goal held by most people in the United States. Because of the large cost of purchasing a home, most people require financial assistance in the purchase of their home. In most instances, a home buyer secures a loan or mortgage for the purchase of the home. A lending institution, such as a mortgage company, then provides the funds so that the purchaser can buy the home. However, over the period of several years, typically 30 years, a purchaser must pay a monthly mortgage payment. Because of the structure of most mortgages, a large portion of each monthly payment, especially at the early years of the term of the loan, is devoted to interest payments on the mortgage. Thus, at the end of the mortgage period, typically the home purchaser has paid a substantial amount on interest (totaling in many cases more than the original purchase price of the home) to the lending institution. The structure of the loan, although it allows the home purchaser to buy and acquire a home, also takes a substantial portion of a person's life to completely own the home. A financial arrangement and method are needed which enables a home purchaser to buy a home in a substantially shorter period of time.

Currently, there are several financial arrangements in place for the purchase of a home. There are several unique financial arrangements, although often not of a great benefit to the home purchaser, which are available to the purchaser. One type of mortgage now available provides an adjustable interest rate based on a national prime lending rate. Oftentimes this adjustable rate may be initially lower than current market interest rates, but over a period of time (e.g., three years), the adjustable rate goes up significantly. This significant rate hike often results in the purchaser being unable to continue making timely mortgage payments. In another type of mortgage plan, a purchaser is provided with an “interest only” mortgage plan where the purchaser is required to merely pay the interest on the mortgage loan. However, with the payment of interest only, the purchases will never pay down the loan and, thus, will never own the home. Also, without gains in the value of the home, the purchaser is unable to obtain equity in the home. In still another type, a financial arrangement is utilized to avoid the payment of interest on a loan. For example, Islamic law prohibits the payment of interest on loans. To circumvent this prohibition of interest, banks have set up innovative financial arrangements to avoid the payment of interest. However, these financial arrangements typically involving a home purchaser and bank partnering in buying a home. The home purchaser then pays a specified amount of fees every month to live and buy back ownership from the bank. However, these financial schemes do not teach or suggest utilizing transactions from other entities to build equity in a home.

In addition, similar problems exist for purchasing other types of assets. Typically, a buyer is unable to purchase a new vehicle. Thus, the buyer must purchase the asset (vehicle) by obtaining a loan. The loans, in a similar manner as home loans, require the payment of interest. The payment of interest extends the amount of time necessary to completely pay back the loan.

Therefore, it would be advantageous to provide a purchaser a financial arrangement and method for obtaining an asset allowing total ownership by the purchaser in a substantially less time period than present loan plans. It is an object of the present invention to provide such an arrangement and method.

### SUMMARY OF THE INVENTION

In one aspect, the present invention is a method of acquiring an asset by a purchaser. The method begins by a purchasing entity purchasing an asset. A contractual relationship between the purchasing entity and the purchaser is then established. The purchaser agrees to pay a periodic fee to utilize the asset and equity is built by the purchaser in the asset by conducting specified transactions. The fee may be any form of payment, such as cash, any financial instrument, checks, shares, rent, or any tangible good or service. The purchaser pays the periodic fee, thereby allowing utilization of the asset. The purchaser conducts the specified transactions with a partnership entity affiliated with the purchasing entity. Equity is then built in the asset by the purchaser by conducting the specified transactions. Total ownership of the asset is transferred from the purchasing entity to the purchaser when the equity equals a specified amount. Additionally, transaction fees may be incurred by the partnership entity to the purchasing entity for each specified transaction.

In another aspect, the present invention is a computing system utilized for acquiring an asset by a purchaser. The system includes a point accumulator for accumulating points acquired by the purchaser when purchasing a good or service from a partnership entity. The accumulated points are converted into an equity balance within an equity balance account. Equity of the asset by the purchaser is then determined based on the equity balance within the equity balance account. The equity is built by the purchaser by purchasing a good or service from the partnership entity.

In still another aspect, the present invention is a method of acquiring a home by a home purchaser. The method begins by a purchasing entity purchasing a home. A contractual relationship is established between the purchasing entity and the home purchaser wherein the home purchaser agrees to pay rent to occupy the home and equity is built by the home purchaser in the home by conducting specified transactions. The home purchaser pays rent, thereby allowing the occupancy of the home. Specified transactions are conducted by the home purchaser with a partnership entity affiliated with the purchasing entity. Equity is built by the home purchaser by conducting the specified transactions. Equity is then determined for the home purchaser of the home, wherein total ownership of the home is transferred from the purchasing entity to the home purchaser when the determined equity equals a specified amount.

### BRIEF DESCRIPTION OF THE DRAWINGS

FIG. 1 is a simplified block diagram of the components of a financial arrangement system in the preferred embodiment of the present invention;

FIG. 2 is a simplified block diagram of a computing system utilized in the financial arrangement system in the preferred embodiment of the present invention;

FIGS. 3A and 3B are flow charts outlining the steps for acquiring a home by a home purchaser according to the teachings of the present invention; and

FIGS. 4A-4C are flow charts outlining the steps for obtaining a home equity loan within the financial arrangement system in a first alternate embodiment of the present invention.

FIG. 5 is a simplified block diagram of the components of a financial arrangement system in a second alternate embodiment of the present invention;

FIG. 6 is a simplified block diagram of a computing system utilized in the financial arrangement system in the second alternate embodiment of the present invention;

FIGS. 7A and 7B are flow charts outlining the steps for acquiring an asset by a purchaser in the second alternate embodiment of the present invention; and

FIGS. 8A-8C are flow charts outlining the steps for obtaining an equity loan within the financial arrangement system in a third alternate embodiment of the present invention.

### DESCRIPTION OF THE INVENTION

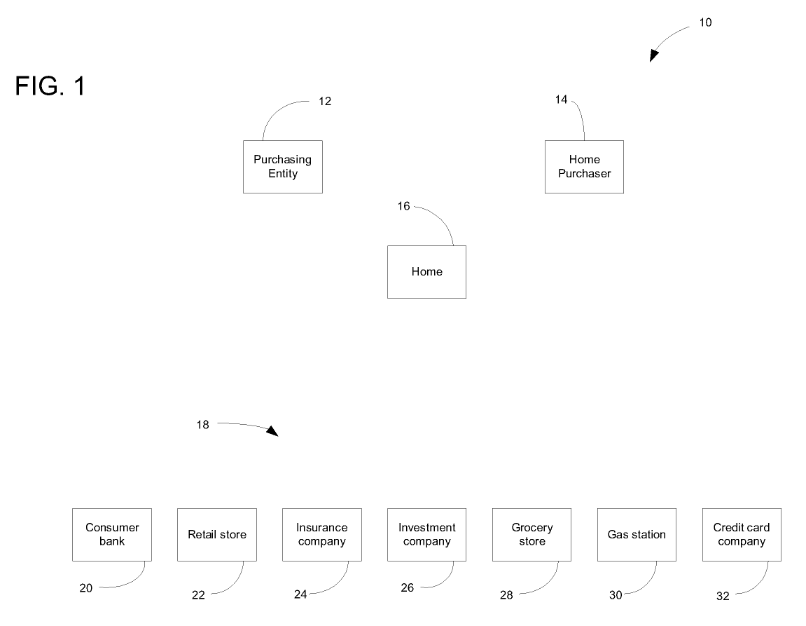

The present invention relates to a financial arrangement and method for the acquisition of an asset by a purchaser. FIG. 1 is a simplified block diagram of the components of a financial arrangement system 10 in the preferred embodiment of the present invention. The financial arrangement system includes a purchasing entity 12, a home purchaser 14 desiring to purchase a home 16, and a plurality of partnership entities 18. The purchasing entity may be any financial institution (such as a bank, a mortgage company, lending institution, etc.), an individual investor, an investing company or any entity, individual, or individuals capable of purchasing the home 16. The home purchaser is any person, persons or entity desiring to purchase or obtain the home.

The plurality of partnership entities 18 may include a consumer bank 20, a retail store 22, an insurance company 24, an investment company 26, a grocery store 28, a gas station 30, and a credit card company 32. A partnership entity may be any entity providing services or goods either directly or indirectly to the home purchaser or an associated entity of the home purchaser (e.g., family).

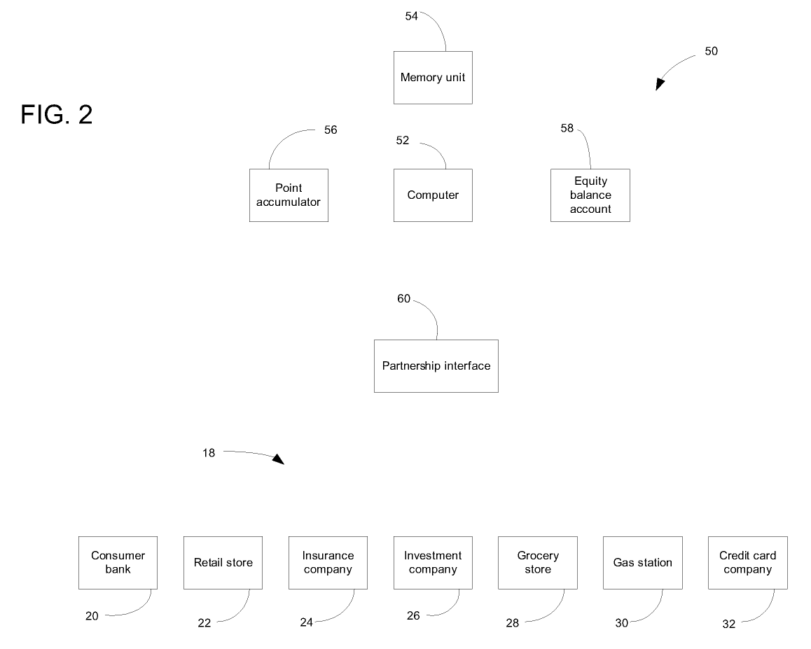

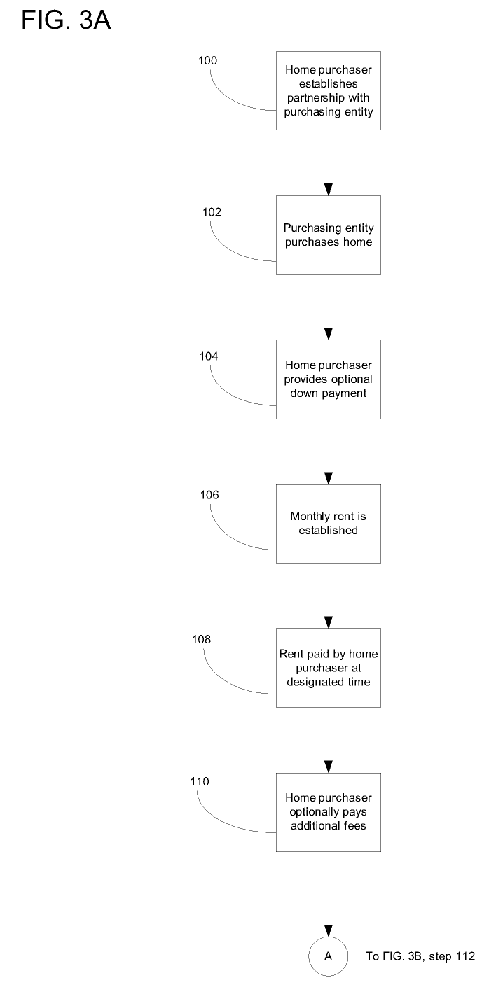

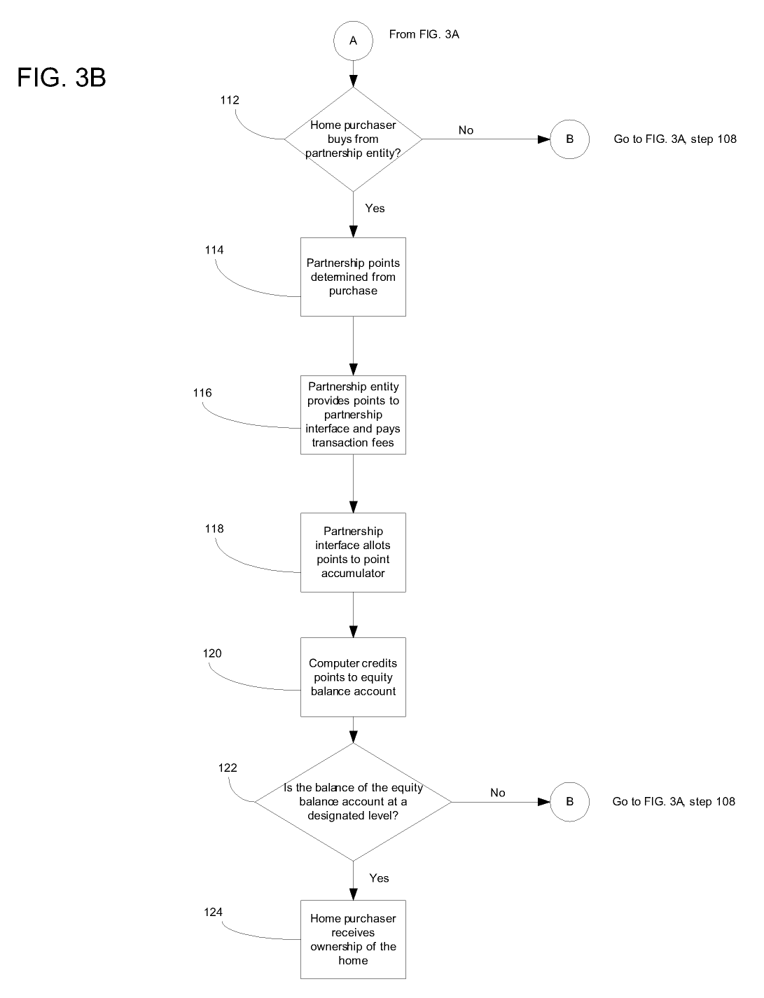

FIG. 2 is a simplified block diagram of a computing system 50 utilized in the financial arrangement system 10 in the preferred embodiment of the present invention. The computing system 50 includes a computer 52, a memory unit 54, a point accumulator 56, an equity balance account 58, and a partnership interface 60. The partnership interface communicates with each of the partnership entities 18 (i.e., consumer bank 20, retail store 22, insurance company 24, investment company 26, grocery store 28, gas station 30, and credit card company 32). In addition, the computing system 50 communicates with the purchasing entity 12.

The computer 52 may be any computing device capable of performing accounting and computational processes commonly utilized in the financial industry. The memory unit allows the storage of data necessary for the computer to conduct the processes utilized in the present invention. The point accumulator 56 accounts for partnership points awarded to the home purchaser 14 when conducting business with any one of the partnership entities 18. The equity balance account 58 provides a balance on the equity held in the home 16 by the home purchaser 14. The partnership interface 60 allows any of the partnership entities to communicate with the computer 52.

With reference to FIGS. 1 and 2, the operation of the financial arrangement system 10 will now be explained. First, the home purchaser 14 desires to acquire the home 16. However, the home purchaser has insufficient funds to purchase the home. The home purchaser then establishes a partnership with the purchasing entity 12. The purchasing entity agrees to purchase the home and rent the home to the home purchase 14. For example, a home may cost $100,000. A monthly rent is then established for which the home purchaser agrees to pay to live in the home. For example, a monthly rent of $100 may be agreed upon by the home purchaser to occupy the home. The monthly rent of $100 merely allows the home purchaser to occupy the home. Alternatively, the rent allows any person or persons designated by the home purchaser to occupy the home, thereby allowing the home purchaser to sublet the home to a third party. In an alternate embodiment of the present invention, the rent may be refundable at some designated time period in the future.

In order to transfer ownership of the home 16 from the purchasing entity to the home purchaser 14, an equity amount of $100,000 must eventually be paid by the home purchaser to the purchasing entity 12. The home purchaser may pay the equity amount in one of several ways. First, the home purchaser may pay more than the monthly rent to the purchasing entity (e.g., more than the $100 monthly rent). For each dollar paid above the monthly rent, a dollar is credited to an equity balance account. Thus, in the example of the monthly rent of $100, if the home purchaser 14 pays $110 dollars, the additional $10 above the monthly rent is credited to the equity balance account 58.

It should be understood at the time of the purchase of the home 16, the purchasing entity 12 owns the home and the home purchaser 14 does not have an ownership stake in the home. The partnership between the home purchaser and the purchasing entity provides a contractual relationship in which the home purchaser may occupy the home (e.g., rent the home). Ownership in the home is acquired by payment into the equity balance account. In the preferred embodiment of the present invention, ownership is acquired once full payment on the balance has been made within the equity balance account. However, in an alternate embodiment of the present invention, fractional ownership may be obtained in relation to the amount of equity within the equity balance account.

The home purchaser 14 may also credit the equity balance account 58 in another way. For each transaction with one of the partnership entities 18, partnership points are awarded to the home purchaser. These partnership points are associated with the amount or type of purchase of the services or goods by the home purchaser from a particular partnership entity. For example, every month the home purchaser must pay an insurance premium for the home purchaser's automobile. If the home purchaser purchases automobile insurance from the insurance company 24, partnership points are associated with each premium amount paid. For example, if the home purchaser pays $100 per month for automobile insurance for one automobile, 10 partnership points may be awarded to the home purchaser. If the home purchaser pays $200 per month for insuring two automobiles, 20 partnership points may be awarded to the home purchaser.

Thus, for each purchase of goods or services by the home purchaser 14 from any of the partnership entities 18, partnership points are awarded to the home purchaser. Each partnership entity that receives a purchase from the home purchaser, determines the amount of the purchase, correlates the purchase with a specified amount of partnership points and communicates with the partnership interface 60. The partnership entity provides the partnership interface 60 with the amount of points awarded to the home purchaser 14.

Upon receipt of the partnership points by the partnership interface 60, the partnership interface 60 allocates the rewarded partnership points to the point accumulator 56. At an established periodic time period or automatically when points are received in the point accumulator, the computer 52 converts the partnership points into an established amount of equity to be credited to the equity balance account 58. For example, for each ten partnership points awarded to the home purchaser 14, a dollar amount of equity may be credited to the home purchaser's equity balance account 58.

Thus, purchases by the home purchaser 14 are indirectly credited to the equity balance account 56. The home purchaser is then able to establish equity in the home purchase through these transactions. Additionally, the home purchaser may pay fees 12 directly into the equity balance account by paying more than the monthly rent.

Additionally, with the purchase of each service and good by the home purchaser 14 from one of the partnership entities 18, the partnership entity pays a partnership transaction fee to the purchasing entity 12. This partnership transaction fee may be based on the amount of the purchase by the home purchaser. Thus, the purchasing entity receives revenue from two sources. First, the monthly rent is paid each month by the home purchaser. Additionally, the purchasing entity may charge transaction fees (e.g., ATM fees), account maintenance fees and service fees to the home purchaser. In addition, the purchasing entity receives partnership transaction fees from each of the partnership entities. However, unlike current loan programs, the home purchaser 14 pays no interest on a loan.

Each partnership entity 18 is willing to pay the partnership transaction fee to the purchasing entity 12 in order to encourage the home purchaser to purchase the goods and services from one of the partnership entities. In one embodiment of the present invention, the partnership entity may advertise itself as a part of a home purchasing alliance with a name or logo advertising it as a member of the alliance which awards partnership points to the equity balance account for a particular purchasing entity.

In one embodiment of the present invention, a home equity loan based on the balance of the equity balance account 58 may be given to the home purchaser 14, if desired. For example, the home purchaser may have a balance of $10000 in the home purchaser's equity balance account 58. The home purchaser may desire to obtain a loan on a fraction of the balance within the equity balance account, e.g., $1000. The purchasing entity 12 may then provide a $1000 equity loan to the home purchaser. The $1000 may be subtracted from the equity balance account, thereby providing a balance of $9000. The home purchaser may then pay additional fees directly to the purchasing entity 12 or purchase services or goods through the partnership entities as discussed above. The home purchaser may elect to pay more than the monthly fee to re-establish the original equity balance within the equity balance account.

The monthly rent paid by the home purchaser allows the home purchaser to occupy the home 16. However, in an alternate embodiment, the monthly rent may also allow the home purchaser to rent the home to another. The rental agreement between the home purchaser and a renter is distinct from the contractual agreement between the purchasing entity and the home purchaser. Thus, the home purchaser may rent to a third party at a rental fee different or the same rate as the monthly rent paid by the home purchaser to the purchasing entity 12.

FIGS. 3A and 3B are flow charts outlining the steps for acquiring a home 16 by a home purchaser 14 according to the teachings of the present invention. With reference to FIGS. 1-3, the method will now be explained. The method begins with step 100 where a home purchaser 14, desiring to obtain ownership of a home 16, establishes a partnership with the purchasing entity 12. In the partnership contractual agreement, the purchasing entity agrees to purchase the home and rent the home to the home purchaser 14. A monthly rent is then established for which the home purchaser agrees to pay to live in the home. For example, a home may cost $100,000 and a monthly rent of $100 may be agreed upon by the home purchaser to allow occupancy of the home purchaser of the home. The monthly rent of $100 merely allows the home purchaser to occupy the home. The partnership between the home purchaser and the purchasing entity provides a contractual relationship in which the home purchaser may occupy the home (e.g., rent the home). Ownership in the home is acquired by payment into the equity balance account.

In step 102, upon establishing a partnership between the purchasing entity 12 and the home purchaser 14, the purchasing entity 12 purchases the home 16. The purchasing entity may purchase the home or secure a loan to purchase the home, or obtain investment funding from another source. Thus, originally, ownership resides with the purchasing entity or other designated entity of the purchasing entity.

Next, in step 104, the home purchaser 14 may optionally provide a down payment to the purchasing entity 12 which may be credited to the equity balance account 58. The method then moves to step 106 where a monthly rent is establish. In order to continue the partnership and allow the home purchaser or other designated person to occupy the home 16, the home purchaser pays the monthly rent to the purchasing entity 12. Alternately, rent may be paid at any agreed upon rate and time period (e.g., yearly lump sum).

In step 108, the home purchaser, at the agreed designated time period, pays the rent to the purchasing entity 12. It should be understood that this rent does not provide any equity or credit to the equity balance account 58. Rather, the rent merely allows the home purchaser or other designated party to occupy the home 16.

In order to acquire the home 16 by the home purchaser 14, the purchase price or other designated amount for determining the equity in the home must be paid by the home purchaser to the purchasing entity 12. For example, if the purchasing entity 12 purchased the home for $100,000, the home purchaser may be required to pay $100,000 into the equity balance account 58 to acquire the home. In step 110, the home purchaser optionally pays more than the $100 monthly rent to the purchasing entity. For each dollar paid above the monthly rent, a dollar is credited to an equity balance account. Thus, in the example of the monthly rent of $100, if the home purchaser 14 pays $110 dollars, the additional $10 above the monthly rent is credited to the equity balance account 58.

In step 112, it is determined if the home purchaser optionally purchases goods or services from one of the plurality of partnership entities 18. If it is determined that the home purchaser does not optionally purchase goods or services, the method moves to step 108.

However, in step 112, if it is determined that the home purchaser optionally purchases goods or services from one of the plurality of partnership entities 18, the method moves from step 112 to step 114 where it is determined the amount of partnership points which should be awarded for the transaction. The partnership points may be based on a specified dollar amount or type of transaction which is designated and agreed upon by the purchasing entity 12 and the specified partnership entity 18. Thus, each partnership entity that receives a purchase from the home purchaser, determines the amount of the purchase, and correlates the purchase with a specified amount of partnership points. Next, in step 116, the partnership entity 18 communicates with the partnership interface 60 and provides the amount of points awarded to the home purchaser 14. In addition, with the purchase of each service and good by the home purchaser 14 from one of the partnership entities 18, the partnership entity pays a partnership transaction fee to the purchasing entity 12. This partnership transaction fee is based on the amount of the purchase by the home purchaser. Each partnership entity 18 is willing to pay the partnership transaction fee to the purchasing entity 12 in order to encourage the home purchaser to purchase the goods and services from one of the partnership entities. In one embodiment of the present invention, the partnership entity may advertise itself as a part of a home purchasing alliance with a name or logo advertising it as a member which awards partnership points to the equity balance account from a particular purchasing entity.

The method then moves to step 118 where, upon receipt of the partnership points by the partnership interface 60, the partnership interface allots the rewarded partnership points to the point accumulator 56. In step 120, at an established periodic time period or automatically when points are received in the point accumulator, the computer 52 converts the partnership points into equity within the equity balance account 58, thereby providing credit within the account 58. In one embodiment, the equity balance account may be associated directly with points only. For example, total ownership of the home may require 10,000 points. Points accumulated may be credited to the balance. Thus, if 10 partnership points are awarded for a particular transaction, 10 points are credited to the account. In another embodiment, the points may be equated to a specified dollar amount within the equity balance account. For example, for each 10 partnership points awarded to the home purchaser 14, a dollar may be credited to the home purchaser's equity balance account 58. Thus, purchases by the home purchaser 14 provide credit to the equity balance account 56. The home purchaser is then able to establish equity in the home purchase by purchasing goods or services from partnership entities 18. Next, in step 122, it is determined if the balance of the equity balance account equals the determined equity amount necessary to obtain ownership of the home by the home purchaser. If it is determined that the balance of the equity balance account is not sufficient to obtain ownership, the method then returns to step 108.

However, in step 122, if it is determined that the amount in the equity balance account is sufficient to obtain ownership, the method moves to step 124 where total ownership (i.e., title) is given to the home purchaser 14. At this point, the home purchaser obtains full ownership of the home 16 and is not required to pay any more rent.

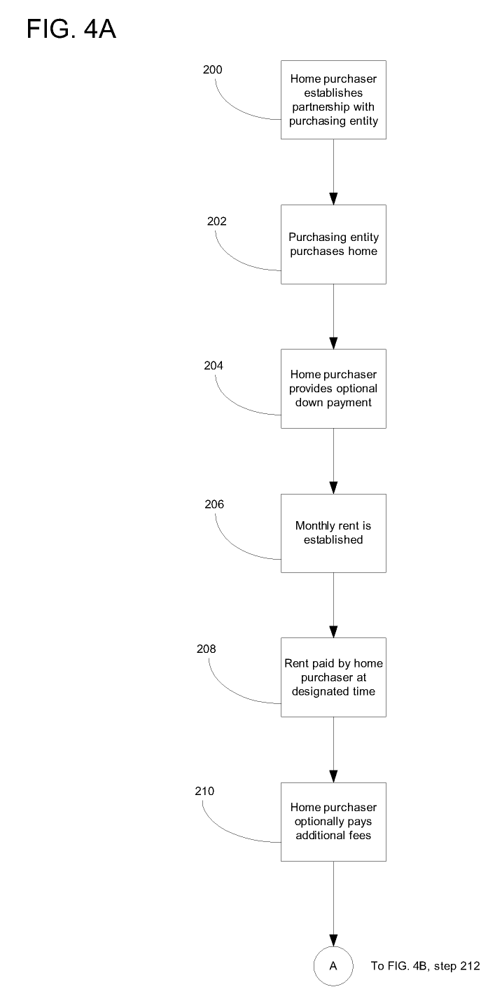

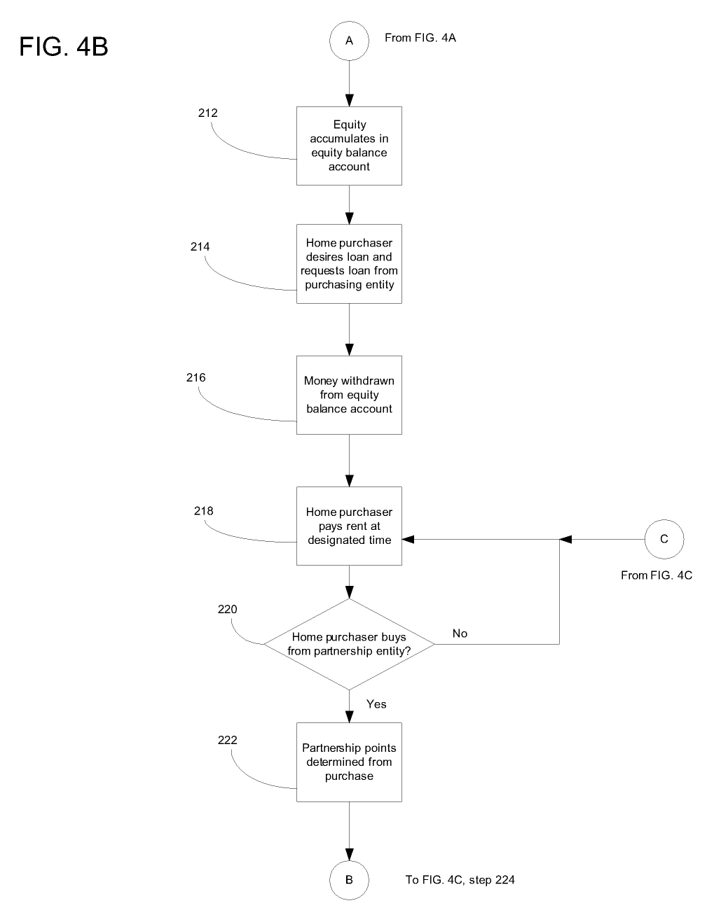

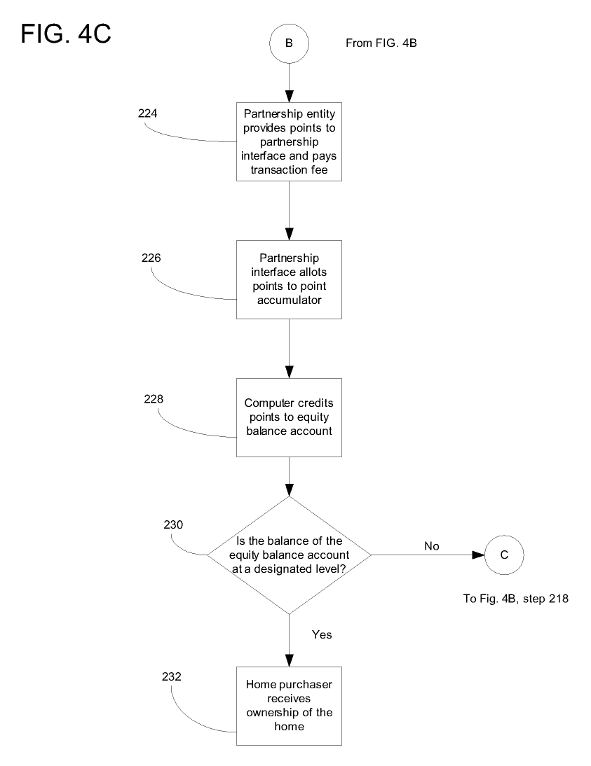

FIGS. 4A-4C are flow charts outlining the steps for obtaining a home equity loan within the financial arrangement system 10 in an alternate embodiment of the present invention. With reference to FIGS. 1-4, the method will now be explained. The method begins with step 200 where a home purchaser 14, desiring to obtain ownership of a home 16, establishes a contractual partnership with the purchasing entity 12. In the partnership agreement, the purchasing entity agrees to purchase the home and rent the home to the home purchase 14. The partnership between the home purchaser and the purchasing entity provides a contractual relationship in which the home purchaser may occupy the home (e.g., rent the home). Ownership in the home is acquired by payment into the equity balance account.

In step 202, upon establishing a partnership between the purchasing entity 12 and the home purchaser 14, the purchasing entity 12 purchases the home 16. The purchasing entity may purchase the home or secure a loan to purchase the home, or obtain investment funding from another source. Thus, originally, ownership resides with the purchasing entity or other designated entity of the purchasing entity.

Next, in step 204, the home purchaser 14 may optionally provide a down payment to the purchasing entity 12 which may be credited to the equity balance account 58. The method then moves to step 206 where a monthly rent is established. In order to continue the partnership and allow the home purchaser or other designated person to occupy the home 16, the home purchaser 14 pays the monthly rent to the purchasing entity 12. Alternately, rent may be paid at any agreed upon rate and time period (e.g., yearly lump sum).

In step 208, the home purchaser, at the agreed designated time period, pays the rent to the purchasing entity 12. It should be understood that this rent does not provide any equity or credit to the equity balance account 58. Rather, the rent merely allows the home purchaser or other designated party to occupy the home 16.

Next, in step 210, the home purchaser optionally pays fees in addition to the rent, which are credited to the equity balance account and/or purchases goods or services from one of the partnership entities 18, which also credits the equity balance account. In step 212, an equity balance is accumulated in the equity balance account from either/or credit from purchases with partnership entities or payment to the equity balance account. The method then moves to step 214, where the home purchaser 14 desires to obtain an equity loan based on the accumulated equity in the equity balance account. The purchasing entity 12, in step 216, provides a loan of the agreed amount from the equity balance account to the home purchaser.

The method then moves to step 218, where the home purchaser, at the agreed designated time period, pays the rent to the purchasing entity 12. The home purchaser may also optionally pay additional fees above the rent which is credited to the equity balance account. Next, in step 220, it is determined if the home purchaser optionally purchases goods or services from one of the plurality of partnership entities 18. If it is determined that the home purchaser does not optionally purchase goods or services, the method moves to step 218.

However, in step 220, if it is determined that the home purchaser optionally purchases goods or services from one of the plurality of partnership entities 18, the method moves from step 220 to step 222 where an amount of partnership points which should be awarded for the transaction is determined. The partnership points may be based on a dollar amount or a type of transaction, which is designated and agreed between the purchasing entity 12 and the specified partnership entity 18. Thus, each partnership entity that receives a purchase from the home purchaser, determines the amount of the purchase, correlates the purchase with a specified amount of partnership points. Next, in step 224, the partnership entity 18 communicates with the partnership interface 60 and provides the amount of points awarded to the home purchaser 14. In addition, with the purchase of each service and good by the home purchaser 14 from one of the partnership entities 18, the partnership entity pays a partnership transaction fee to the purchasing entity 12. This partnership transaction fee is based on the amount of the purchase by the home purchaser. Each partnership entity 18 is willing to pay the partnership transaction fee to the purchasing entity 12 in order to encourage the home purchaser to purchase the goods and services from one of the partnership entities. In one embodiment of the present invention, the partnership entity may advertise itself as a part of a home purchasing alliance or network with a name or logo advertising it as a member who awards partnership points to the equity balance account from a particular purchasing entity.

The method then moves to step 226 where, upon receipt of the partnership points by the partnership interface 60, the partnership interface allots the rewarded partnership points to the point accumulator 56. In step 228, at an established periodic time period or automatically when points are received in the point accumulator, the computer 52 converts the partnership points into equity credited to the equity balance account 58. In one embodiment, the equity balance account may be associated directly with points only. For example, total ownership of the home may require 10,000 points. Points accumulated may be credited to the balance. Thus, if 10 partnership points are awarded for a particular transaction, 10 points are credited to the account. In another embodiment, the points may be equated to a specified dollar amount within the equity balance account. For example, for each 10 partnership points awarded to the home purchaser 14, a dollar may be credited to the home purchaser's equity balance account 58. Thus, purchases by the home purchaser 14 provide credit to the equity balance account 56. The home purchaser is then able to establish equity in the home purchase by purchasing goods or services from partnership entities 18. Next, in step 230, it is determined if the balance of the equity balance account equals the determined equity amount necessary to obtain ownership of the home by the home purchaser. If it is determined that the balance of the equity balance account is not sufficient to obtain ownership, the method then returns to step 218.

However, in step 230, if it is determined that the amount in the equity balance account is sufficient to obtain ownership, the method moves to step 232 where total ownership (i.e., title) is given to the home purchaser 14. At this point, the home purchaser obtains full ownership of the home 16 and is not required to pay any more rent.

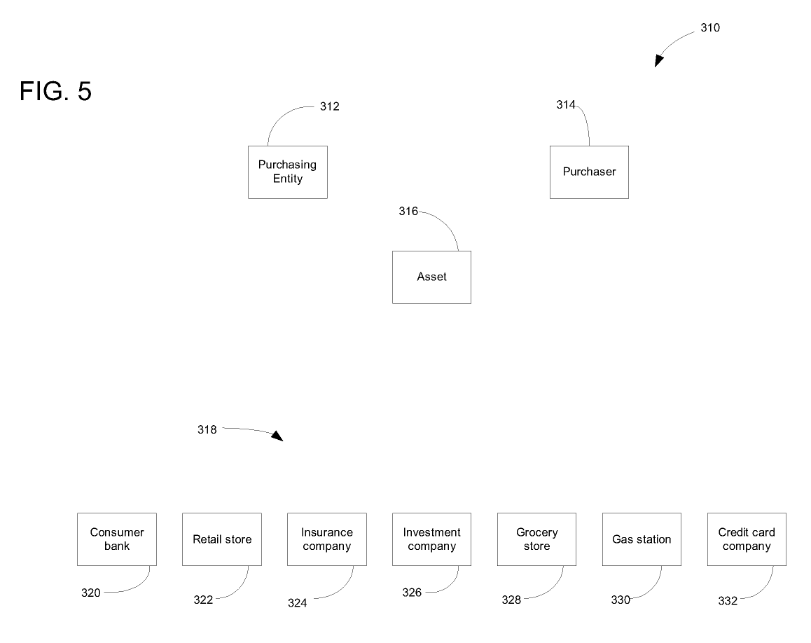

The present invention may be utilized for the purchase of any asset. FIG. 5 is a simplified block diagram of the components of a financial arrangement system 310 in an alternate embodiment of the present invention. The financial arrangement system includes a purchasing entity 312, a purchaser 314 desiring to purchase an asset 316, and a plurality of partnership entities 318. The purchasing entity may be any financial institution (such as a bank, a mortgage company, lending institution, etc.), an individual investor, an investing company or any entity, individual, or individuals capable of purchasing the asset 316. The purchaser is any person, persons or entity desiring to purchase or obtain the asset.

The plurality of partnership entities 318 may include a consumer bank 320, a retail store 322, an insurance company 324, an investment company 326, a grocery store 328, a gas station 330, and a credit card company 332. A partnership entity may be any entity providing services or goods either directly or indirectly to the purchaser or an associated entity of the purchaser (e.g., family).

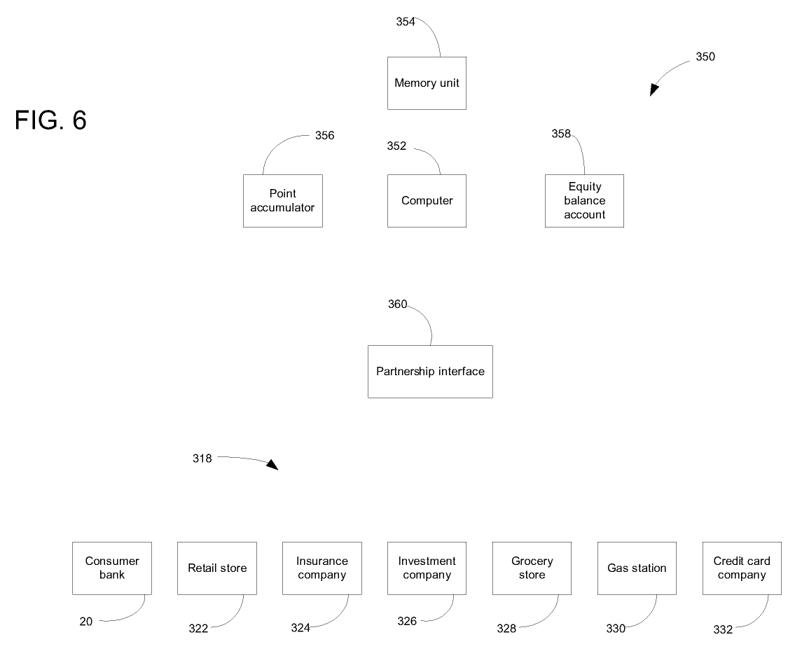

FIG. 6 is a simplified block diagram of a computing system 350 utilized in the financial arrangement system 310 in an alternate embodiment of the present invention. The computing system 350 is similar to the computing system 50 and includes a computer 352, a memory unit 354, a point accumulator 356, an equity balance account 358, and a partnership interface 360. The partnership interface communicates with each of the partnership entities 318 (i.e., consumer bank 320, retail store 322, insurance company 324, investment company 326, grocery store 328, gas station 330, and credit card company 332). In addition, the computing system 350 communicates with the purchasing entity 312.

The computer 352 may be any computing device capable of performing accounting and computational processes commonly utilized in the financial industry. The memory unit allows the storage of data necessary for the computer to conduct the processes utilized in the present invention. The point accumulator 356 accounts for partnership points awarded to the purchaser 314 when conducting business with any one of the partnership entities 318. The equity balance account 358 provides a balance on the equity held in the asset 316 by the purchaser 314. The partnership interface 360 allows any of the partnership entities to communicate with the computer 352.

With reference to FIGS. 5 and 6, the operation of the financial arrangement system 310 will now be explained. First, the purchaser 314 desires to acquire the asset 316. However, the purchaser has insufficient funds to purchase the asset. The purchaser then establishes a partnership with the purchasing entity 312. The purchasing entity agrees to purchase the asset and allow the purchaser 314 to use the asset. For example, an asset may cost $10,000. A monthly fee may then be established for which the purchaser agrees to pay to use the asset. For example, a monthly fee of $10 may be agreed upon by the purchaser to utilize the asset. The monthly fee of $100 merely allows the purchaser to utilize the asset. Alternatively, the fee allows any person or persons designated by the purchaser to use the asset, thereby allowing the purchaser to sublet the asset to a third party. The fee may be any form of payment, such as cash, any financial instrument, checks, shares, rent, or any tangible good or service. In an alternate embodiment of the present invention, the fee may be refundable.

In order to transfer ownership of the asset 316 from the purchasing entity to the purchaser 314, an equity amount of $10,000 must eventually be paid by the purchaser to the purchasing entity 312. The purchaser may pay the equity amount in one of several ways. First, the purchaser may pay more than the monthly fee to the purchasing entity (e.g., more than the $10 monthly fee). For each dollar paid above the monthly fee, a dollar is credited to an equity balance account. Thus, in the example of the monthly fee of $10, if the purchaser 314 pays $11 dollars, the additional $1 above the monthly fee is credited to the equity balance account 358.

It should be understood at the time of the purchase of the asset 16, the purchasing entity 312 owns the asset and the purchaser 314 does not have an ownership stake in the asset. The partnership between the purchaser and the purchasing entity provides a contractual relationship in which the purchaser may occupy the asset (e.g., rent the asset). Ownership in the asset is acquired by payment into the equity balance account. In the preferred embodiment of the present invention, ownership is acquired once full payment on the balance has been made within the equity balance account. However, in an alternate embodiment of the present invention, fractional ownership may be obtained in relation to the amount of equity within the equity balance account.

The purchaser 314 may also credit the equity balance account 358 in another way. For each transaction with one of the partnership entities 318, partnership points are awarded to the purchaser. These partnership points are associated with the amount or type of purchase of the services or goods by the purchaser from a particular partnership entity. For example, every month the purchaser must pay an insurance premium for the purchaser's automobile. If the purchaser purchases automobile insurance from the insurance company 324, partnership points are associated with each premium amount paid. For example, if the purchaser pays $10 per month for automobile insurance for one automobile, 10 partnership points may be awarded to the purchaser. If the purchaser pays $20 per month for insuring two automobiles, 20 partnership points may be awarded to the purchaser.

Thus, for each purchase of goods or services by the purchaser 14 from any of the partnership entities 318, partnership points are awarded to the purchaser. Each partnership entity that receives a purchase from the purchaser, determines the amount of the purchase, correlates the purchase with a specified amount of partnership points and communicates with the partnership interface 360. The partnership entity provides the partnership interface 360 with the amount of points awarded to the purchaser 314.

Upon receipt of the partnership points by the partnership interface 360, the partnership interface 360 allocates the rewarded partnership points to the point accumulator 356. At an established periodic time period or automatically when points are received in the point accumulator, the computer 352 converts the partnership points into an established amount of equity to be credited to the equity balance account 358. For example, for each ten partnership points awarded to the purchaser 314, a dollar amount of equity may be credited to the purchaser's equity balance account 358.

Thus, purchases by the purchaser 314 are indirectly credited to the equity balance account 356. The purchaser is then able to establish equity in the asset purchase through these transactions. Additionally, the purchaser may pay fees 312 directly into the equity balance account by paying more than the monthly fee.

Additionally, with the purchase of each service and good by the purchaser 314 from one of the partnership entities 318, the partnership entity pays a partnership transaction fee to the purchasing entity 312. This partnership transaction fee may be based on the amount of the purchase by the purchaser. Thus, the purchasing entity receives revenue from two sources. First, the monthly fee is paid each month by the purchaser. Additionally, the purchasing entity may charge transaction fees (e.g., ATM fees), account maintenance fees and service fees to the purchaser. In addition, the purchasing entity receives partnership transaction fees from each of the partnership entities. However, unlike current loan programs, the purchaser 14 pays no interest on a loan.

Each partnership entity 18 is willing to pay the partnership transaction fee to the purchasing entity 312 in order to encourage the purchaser to purchase the goods and services from one of the partnership entities. In one embodiment of the present invention, the partnership entity may advertise itself as a part of an asset purchasing alliance with a name or logo advertising it as a member of the alliance which awards partnership points to the equity balance account for a particular purchasing entity.

In one embodiment of the present invention, an asset equity loan based on the balance of the equity balance account 358 may be given to the purchaser 314, if desired. For example, the purchaser may have a balance of $1,000 in the purchaser's equity balance account 358. The purchaser may desire to obtain a loan on a fraction of the balance within the equity balance account, e.g., $100. The purchasing entity 312 may then provide a $100 equity loan to the purchaser. The $100 may be subtracted from the equity balance account, thereby providing a balance of $900. The purchaser may then pay additional fees directly to the purchasing entity 312 or purchase services or goods through the partnership entities as discussed above. The purchaser may elect to pay more than the monthly fee to re-establish the original equity balance within the equity balance account.

The monthly fee paid by the purchaser allows the purchaser to occupy the asset 316. However, in an alternate embodiment, the monthly fee may also allow the purchaser to sublet the asset to another.

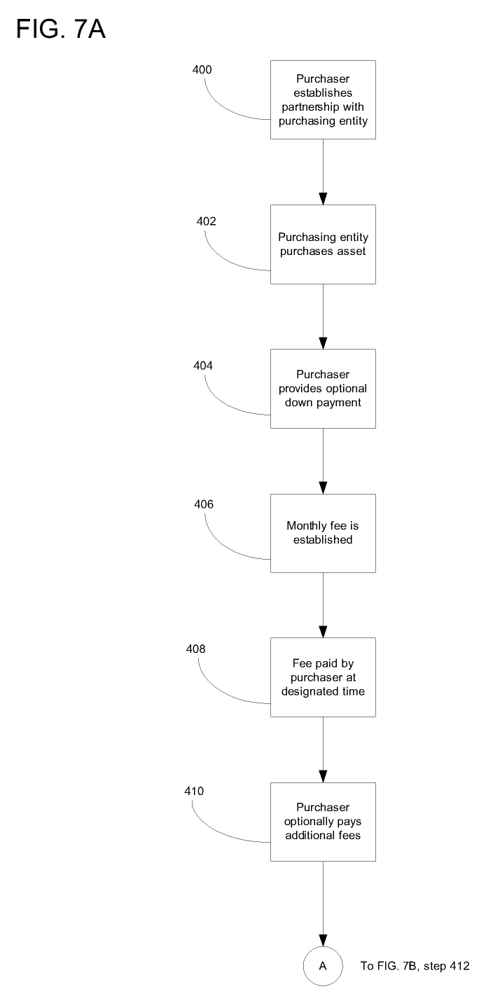

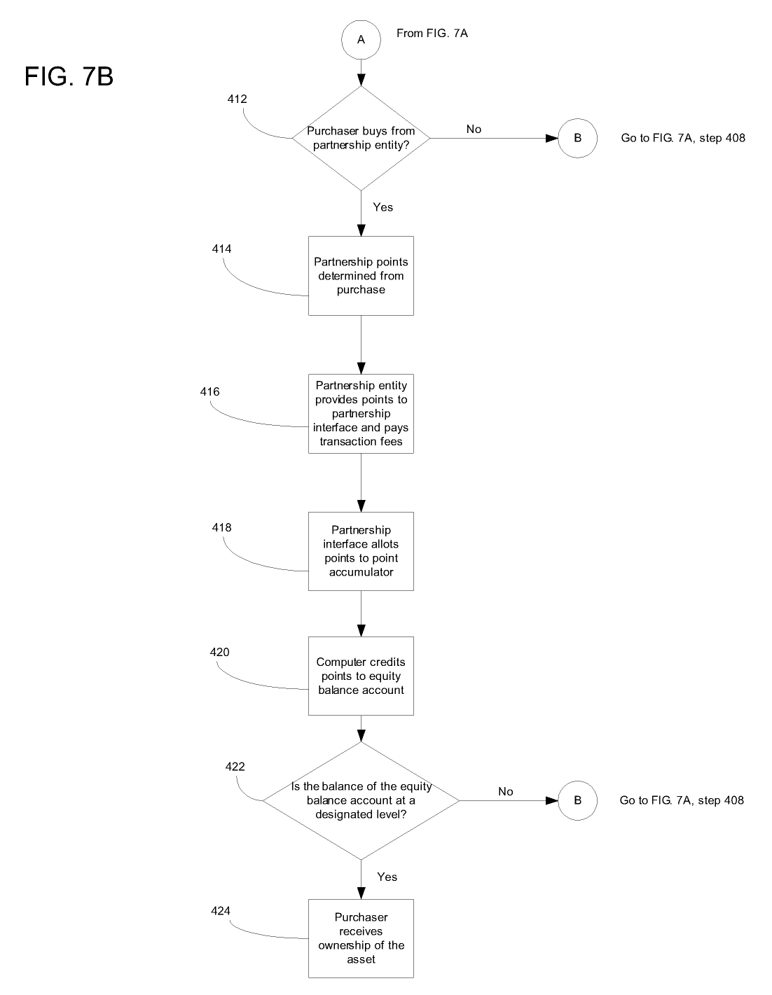

FIGS. 7A and 7B are flow charts outlining the steps for acquiring an asset 316 by a purchaser 314 in an alternate embodiment of the present invention. With reference to FIGS. 5-7, the method will now be explained. The method begins with step 400 where a purchaser 314, desiring to obtain ownership of an asset 316, establishes a partnership with the purchasing entity 312. In the partnership contractual agreement, the purchasing entity agrees to purchase the asset and rent the asset to the purchaser 314. A monthly fee is then established for which the purchaser agrees to pay to utilize the asset. For example, an asset may cost $10,000 and a monthly fee of $10 may be agreed upon by the purchaser to utilize the asset. The monthly fee of $10 merely allows the purchaser to utilize the asset. The partnership between the purchaser and the purchasing entity provides a contractual relationship in which the purchaser may utilize the asset (e.g., rent the asset). Ownership in the asset is acquired by payment into the equity balance account.

In step 402, upon establishing a partnership between the purchasing entity 312 and the purchaser 314, the purchasing entity 312 purchases the asset 316. The purchasing entity may purchase the asset or secure a loan to purchase the asset, or obtain investment funding from another source. Thus, originally, ownership resides with the purchasing entity or other designated entity of the purchasing entity.

Next, in step 404, the asset purchaser 314 may optionally provide a down payment to the purchasing entity 312 which may be credited to the equity balance account 358. The method then moves to step 406 where a monthly fee is establish. In order to continue the partnership and allow the purchaser or other designated person to utilize the asset 316, the purchaser pays the monthly (or other designated time period) fee to the purchasing entity 312. Alternately, the fee may be paid at any agreed upon rate and time period (e.g., yearly lump sum).

In step 408, the purchaser, at the agreed designated time period, pays the fee to the purchasing entity 312. It should be understood that this fee does not provide any equity or credit to the equity balance account 58. Rather, the fee merely allows the purchaser or other designated party to utilize the asset 16.

In order to acquire the asset 316 by the purchaser 314, the purchase price or other designated amount for determining the equity in the asset must be paid by the purchaser to the purchasing entity 312. For example, if the purchasing entity 312 purchased the asset for $10,000, the purchaser may be required to pay $10,000 into the equity balance account 58 to acquire the asset. In step 110, the purchaser optionally pays more than the $10 monthly fee to the purchasing entity. For each dollar paid above the monthly fee, a dollar is credited to an equity balance account. Thus, in the example of the monthly fee of $100, if the purchaser 314 pays $110 dollars, the additional $10 above the monthly fee is credited to the equity balance account 358.

In step 412, it is determined if the purchaser optionally purchases goods or services from one of the plurality of partnership entities 318. If it is determined that the purchaser does not optionally purchase goods or services, the method moves to step 408.

However, in step 412, if it is determined that the purchaser optionally purchases goods or services from one of the plurality of partnership entities 318, the method moves from step 412 to step 414 where it is determined the amount of partnership points which should be awarded for the transaction. The partnership points may be based on a specified dollar amount or type of transaction which is designated and agreed upon by the purchasing entity 312 and the specified partnership entity 318. Thus, each partnership entity that receives a purchase from the purchaser, determines the amount of the purchase, and correlates the purchase with a specified amount of partnership points. Next, in step 416, the partnership entity 318 communicates with the partnership interface 360 and provides the amount of points awarded to the purchaser 314. In addition, with the purchase of each service and good by the purchaser 314 from one of the partnership entities 318, the partnership entity pays a partnership transaction fee to the purchasing entity 312. This partnership transaction fee is based on the amount of the purchase by the purchaser. Each partnership entity 318 is willing to pay the partnership transaction fee to the purchasing entity 312 in order to encourage the purchaser to purchase the goods and services from one of the partnership entities. In one embodiment of the present invention, the partnership entity may advertise itself as a part of an asset purchasing alliance with a name or logo advertising it as a member which awards partnership points to the equity balance account from a particular purchasing entity.

The method then moves to step 418 where, upon receipt of the partnership points by the partnership interface 360, the partnership interface allots the rewarded partnership points to the point accumulator 356. In step 420, at an established periodic time period or automatically when points are received in the point accumulator, the computer 352 converts the partnership points into equity within the equity balance account 358, thereby providing credit within the account 358. In one embodiment, the equity balance account may be associated directly with points only. For example, total ownership of the asset may require 10,000 points. Points accumulated may be credited to the balance. Thus, if 10 partnership points are awarded for a particular transaction, 10 points are credited to the account. In another embodiment, the points may be equated to a specified dollar amount within the equity balance account. For example, for each 10 partnership points awarded to the purchaser 314, a dollar may be credited to the purchaser's equity balance account 358. Thus, purchases by the purchaser 314 provide credit to the equity balance account 356. The purchaser is then able to establish equity in the asset purchase by purchasing goods or services from partnership entities 318. Next, in step 422, it is determined if the balance of the equity balance account equals the determined equity amount necessary to obtain ownership of the asset by the purchaser. If it is determined that the balance of the equity balance account is not sufficient to obtain ownership, the method then returns to step 408.

However, in step 422, if it is determined that the amount in the equity balance account is sufficient to obtain ownership, the method moves to step 424 where total ownership (i.e., title) is given to the purchaser 314. At this point, the purchaser obtains full ownership of the asset 316 and is not required to pay any more fees.

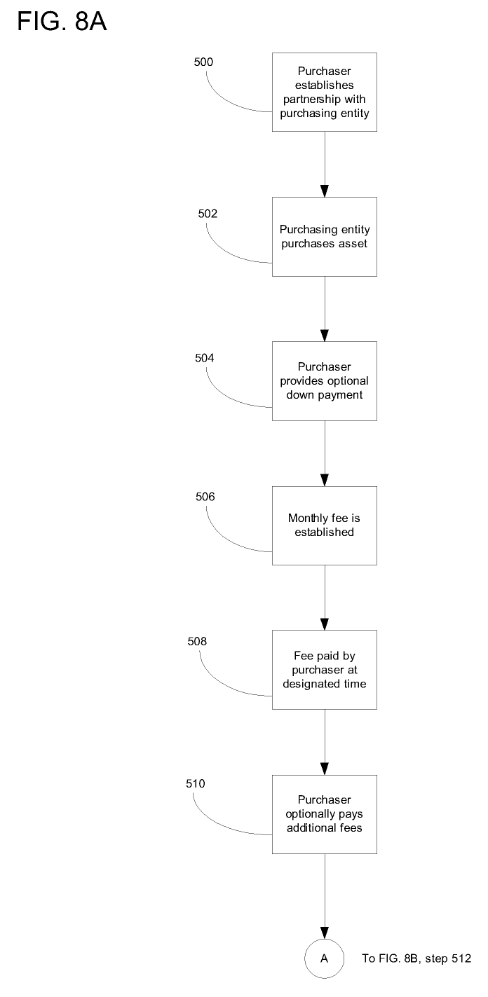

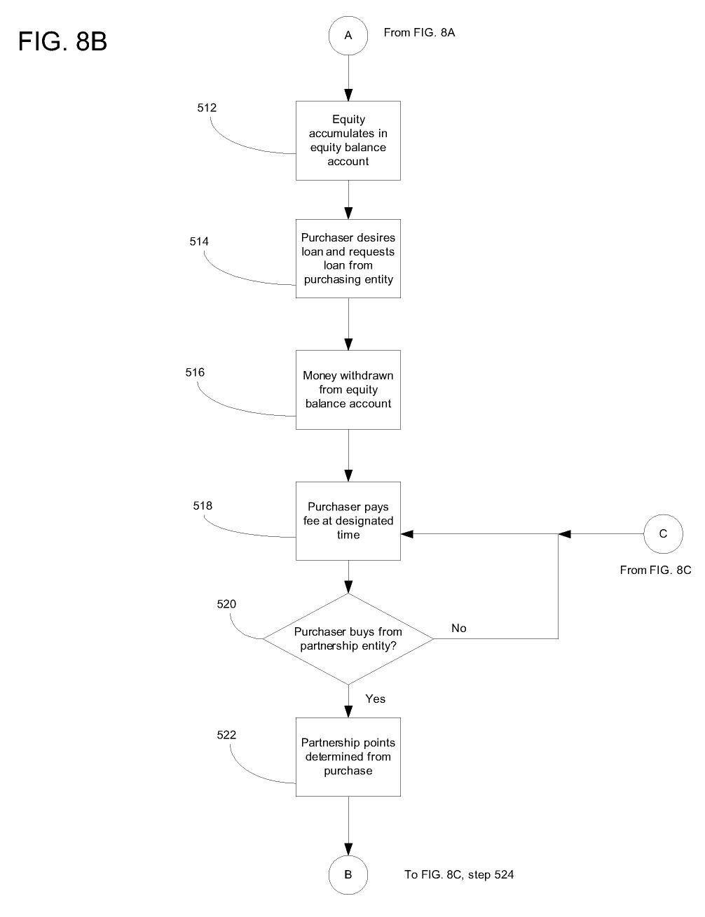

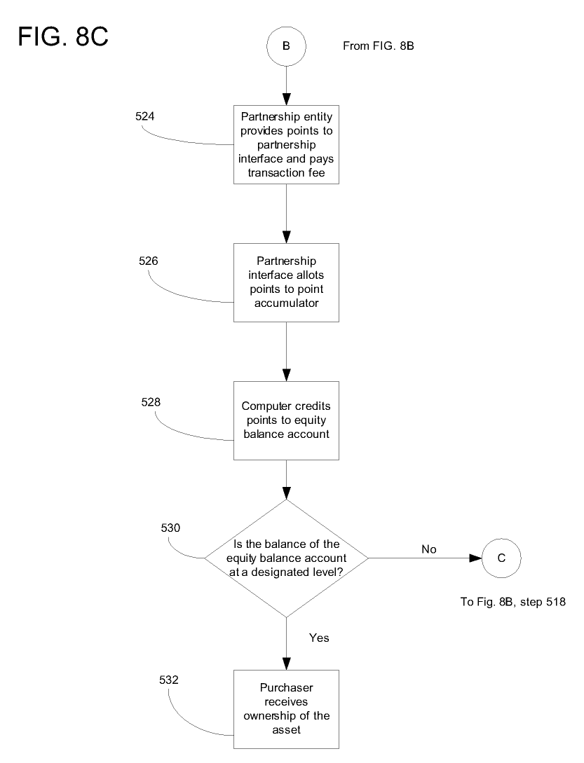

FIGS. 8A-8C are flow charts outlining the steps for obtaining an asset equity loan within the financial arrangement system 310 in an alternate embodiment of the present invention. With reference to FIGS. 5-8, the method will now be explained. The method begins with step 500 where a purchaser 314, desiring to obtain ownership of an asset 316, establishes a contractual partnership with the purchasing entity 312. In the partnership agreement, the purchasing entity agrees to purchase the asset and rent the asset to the asset purchase 314. The partnership between the purchaser and the purchasing entity provides a contractual relationship in which the purchaser may occupy the asset (e.g., rent the asset). Ownership in the asset is acquired by payment into the equity balance account.

In step 502, upon establishing a partnership between the purchasing entity 312 and the purchaser 314, the purchasing entity 312 purchases the asset 316. The purchasing entity may purchase the asset or secure a loan to purchase the asset, or obtain investment funding from another source. Thus, originally, ownership resides with the purchasing entity or other designated entity of the purchasing entity.

Next, in step 504, the asset purchaser 314 may optionally provide a down payment to the purchasing entity 312 which may be credited to the equity balance account 358. The method then moves to step 506 where a monthly fee is established. In order to continue the partnership and allow the purchaser or other designated person to utilize the asset 316, the purchaser 314 pays the monthly fee to the purchasing entity 312. Alternately, the fee may be paid at any agreed upon rate and time period (e.g., yearly lump sum).

In step 508, the purchaser, at the agreed designated time period, pays the fee to the purchasing entity 312. It should be understood that this fee does not provide any equity or credit to the equity balance account 58. Rather, the fee merely allows the purchaser or other designated party to occupy the asset 316.

Next, in step 510, the purchaser optionally pays fees in addition to the designated fee, which are credited to the equity balance account and/or purchases goods or services from one of the partnership entities 318, which also credits the equity balance account. In step 512, an equity balance is accumulated in the equity balance account from either/or credit from purchases with partnership entities or payment to the equity balance account. The method then moves to step 514, where the purchaser 314 desires to obtain an equity loan based on the accumulated equity in the equity balance account. The purchasing entity 312, in step 516, provides a loan of the agreed amount from the equity balance account to the purchaser.

The method then moves to step 518, where the purchaser, at the agreed designated time period, pays the designated fee to the purchasing entity 312. The purchaser may also optionally pay additional fees above the designated fee which is credited to the equity balance account. Next, in step 520, it is determined if the purchaser optionally purchases goods or services from one of the plurality of partnership entities 318. If it is determined that the purchaser does not optionally purchase goods or services, the method moves to step 518.

However, in step 520, if it is determined that the purchaser optionally purchases goods or services from one of the plurality of partnership entities 318, the method moves from step 520 to step 522 where an amount of partnership points which should be awarded for the transaction is determined. The partnership points may be based on a dollar amount or a type of transaction, which is designated and agreed between the purchasing entity 312 and the specified partnership entity 318. Thus, each partnership entity that receives a purchase from the purchaser, determines the amount of the purchase, correlates the purchase with a specified amount of partnership points. Next, in step 524, the partnership entity 318 communicates with the partnership interface 360 and provides the amount of points awarded to the purchaser 314. In addition, with the purchase of each service and good by the purchaser 314 from one of the partnership entities 318, the partnership entity pays a partnership transaction fee to the purchasing entity 312. This partnership transaction fee is based on the amount of the purchase by the purchaser. Each partnership entity 318 is willing to pay the partnership transaction fee to the purchasing entity 312 in order to encourage the purchaser to purchase the goods and services from one of the partnership entities. In one embodiment of the present invention, the partnership entity may advertise itself as a part of an asset purchasing alliance or network with a name or logo advertising it as a member who awards partnership points to the equity balance account from a particular purchasing entity.

The method then moves to step 526 where, upon receipt of the partnership points by the partnership interface 360, the partnership interface allots the rewarded partnership points to the point accumulator 356. In step 528, at an established periodic time period or automatically when points are received in the point accumulator, the computer 352 converts the partnership points into equity credited to the equity balance account 358. In one embodiment, the equity balance account may be associated directly with points only. For example, total ownership of the asset may require 10,000 points. Points accumulated may be credited to the balance. Thus, if 10 partnership points are awarded for a particular transaction, 10 points are credited to the account. In another embodiment, the points may be equated to a specified dollar amount within the equity balance account. For example, for each 10 partnership points awarded to the purchaser 314, a dollar may be credited to the purchaser's equity balance account 358. Thus, purchases by the purchaser 314 provide credit to the equity balance account 356. The purchaser is then able to establish equity in the asset purchase by purchasing goods or services from partnership entities 318. Next, in step 530, it is determined if the balance of the equity balance account equals the determined equity amount necessary to obtain ownership of the asset by the purchaser. If it is determined that the balance of the equity balance account is not sufficient to obtain ownership, the method then returns to step 218.

However, in step 530, if it is determined that the amount in the equity balance account is sufficient to obtain ownership, the method moves to step 232 where total ownership (i.e., title) is given to the purchaser 314. At this point, the purchaser obtains full ownership of the asset 316 and is not required to pay any more fees.

It should be understood that the financial arrangement system 10 is distinctly different than the reward programs currently being utilized by airlines and credit card companies. Existing reward programs award points for each transaction to a reward point account. The purchaser may redeem these points for various items, such as free airline tickets or hotel rooms. However, the present invention provides a partnership with a purchaser where the purchasing entity actually purchases the asset and provides the asset, for a monthly fee, to the purchaser. Equity is gained through the partnership point program through the purchases of services and goods from the partnership entities as well as direct payment to the equity balance account. Thus, the present invention provides a partnership point program with an asset purchase program.

The present invention may be utilized to obtain any asset. For example, a purchase may utilize the present invention to purchase land, vehicles, or other valuable assets that the purchaser is unable to purchase outright.

The present invention provides leverage in obtaining equity in the asset through purchases by purchaser from the partnership entities. By utilizing this system and method, no interest is needed to be paid by the purchaser. Thus, without the onerous interest payments as well as the credit obtain through the purchaser's purchases, the purchaser is able to obtain ownership of the asset in a far shorter time period than conventional loans. Additionally, the transaction fees provide revenue to the purchasing entity which is not available in conventional loans. The partnership entities provide the transaction fees to the purchasing entity because consumers are more likely to purchase the services or goods.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

What is claimed is:

1. A method of acquiring an asset by a purchaser, the method comprising the steps of:
purchasing an asset by a purchasing entity;
establishing a contractual relationship between the purchasing entity and the purchaser wherein the purchaser agrees to pay a periodic fee at a periodic specified time period to utilize the asset and equity is built by the purchaser in the asset by conducting specified transactions;
paying the periodic fee by the purchaser, the fee allowing utilization of the asset;
building equity in the asset by the purchaser by conducting specified transactions; and
determining the equity held by the purchaser of the asset, wherein total ownership of the asset is transferred from the purchasing entity to the purchaser when the determined equity equals a specified amount.

2. The method of acquiring an asset by a purchaser of claim 1 wherein the step of building equity in the asset includes paying additional fees above the periodic fee by the asset, the additional fees being credited as equity in the asset.

3. The method of acquiring an asset by a purchaser of claim 1 wherein the step of building equity in the asset includes the steps of:
awarding points for purchases by the purchaser to a partnership entity affiliated with the purchasing entity; and
converting the awarded points into equity.

4. The method of acquiring an asset by a purchaser of claim 1 further comprising the step of extracting the equity in the asset by the purchaser.

5. The method of acquiring an asset by a purchaser of claim 4 wherein the extracted equity is converted into a specified amount of money for the purchaser and the determined equity is reduced by the specified amount of money.

6. The method of acquiring an asset by a purchaser of claim 4 wherein the step of building equity in the asset includes the steps of:
awarding points for purchases by the purchaser to a partnership entity affiliated with the purchasing entity; and
converting the awarded points into equity.

7. The method of acquiring an asset by a purchaser of claim 1 wherein the purchaser fractionally owns the asset, a fractional ownership of the asset being based on the amount of equity held by the purchaser.

8. The method of acquiring an asset by a purchaser of claim 6 wherein the specific amount equals the purchase price of the asset by the purchasing entity.

9. The method of acquiring an asset by a purchaser of claim 1 the step of building equity in the asset by the purchaser includes paying a down payment to the purchasing entity upon establishing the contractual relationship.

10. The method of acquiring an asset by a purchaser of claim 1 wherein the step of building equity in the asset includes the steps of:
awarding points for purchases by the purchaser to a partnership entity affiliated with the purchasing entity;
converting the awarded points into equity; and
paying a transaction fee by the partnership entity to the purchasing entity for each purchase.

11. The method of acquiring an asset by a purchaser of claim 1 wherein:
the asset is a home;
the periodic fee is rent; and
payment of the rent allows occupancy of the home.

12. A computing system utilized for acquiring an asset by a purchaser, the system comprising:
means for accumulating points acquired by the purchaser when purchasing a good or service from a partnership entity;
means for converting the accumulated points into an equity balance within an equity balance account; and
means for determining equity of the asset by the purchaser based on the equity balance within the equity balance account;
wherein the equity is built by the purchaser by purchasing a good or service from the partnership entity.

13. The computing system of claim 12 wherein:
the partnership entity is affiliated with a purchasing entity owning the asset; and
means for charging transaction fees by the purchasing entity to the partnership entity for each purchase of a good or service by the purchaser.

14. The computing system of claim 13 wherein total ownership of the asset is transferred from the purchasing entity to the purchaser when the determined equity equals a specified amount.

15. The computing system of claim 13 wherein the purchaser fractionally owns the asset, a fractional ownership of the asset being based on the amount of equity held by the purchaser.

16. The computing system of claim 13 further comprising means for extracting the equity in the asset by the purchaser, wherein the extracted equity is converted into a specified amount of money for the purchaser and the determined equity is reduced by the specified amount of money.

17. The computing system of claim 13 further comprising means for awarding specified points for purchases by the purchaser to the partnership entity affiliated with the purchasing entity.

18. The computing system of claim 12 wherein the asset is a home.

19. A method of acquiring a home by a home purchaser, the method comprising the steps of:
purchasing a home by a purchasing entity;
establishing a contractual relationship between the purchasing entity and the home purchaser wherein the home purchaser agrees to pay rent to occupy the home and equity is built by the home purchaser in the home by conducting specified transactions;
paying rent by the home purchaser, the rent allowing occupancy of the home;
conducting the specified transactions by the home purchaser with a partnership entity affiliated with the purchasing entity;
building equity in the home by the home purchaser by conducting the specified transactions; and
determining the equity held by the home purchaser of the home, wherein total ownership of the home is transferred from the purchasing entity to the home purchaser when the determined equity equals a specified amount.

20. The method of acquiring a home by a home purchaser of claim 19 further comprising the step of incurring a transaction fee by the partnership entity to the purchasing entity for each specified transaction with the home purchaser.
